(19) United States
(12) Patent Application Publication
(10) Pub. No.: US 2003/0078360 A1
(43) Pub. Date: Apr. 24, 2003

(54) Process for producing solid polyurethane moldings

(76) Inventors: Andreas Hoffmann, Koln (DE); Alfred Neuhaus, Leichlingen (DE); Norbert Eisen, Koln (DE)

Correspondence Address: BAYER CORPORATION, 100 BAYER ROAD, PITTSBURGH, PA, 15205, US

(21) Appl. No.: 10/268,208

(22) Filed: Oct. 10, 2002

(30) Foreign Application Priority Data
Oct. 15, 2001 (DE) 10150558.2

(51) Int. Cl. C08G 18/00

(52) U.S. Cl. 528/44

(57) ABSTRACT

Solid polyurethane moldings having high inherent rigidity, thin walls and a complex geometry are produced. These polyurethane moldings can be produced by reacting a selected polyisocyanate with a selected compound having groups that are capable of reacting with isocyanate groups by means of the casting process which is a simple and inexpensive processing technology.

### BACKGROUND OF THE INVENTION

The present invention concerns a process for producing solid polyurethane moldings which because of their high inherent rigidity (flexural modulus of elasticity>1800 N/mm² according to DIN 53 457) are suitable for the production of articles having thin walls and a complex geometry. These moldings may be produced by reacting at least one of a select group of organic polyisocyanates with a select group of compounds having groups that are capable of reacting with isocyanate groups in a casting process.

Polyurethane casting compounds have long been known (See, e.g., Kunststoff-Handbuch, Volume VII “Polyurethane”, 3^{rd} edition, Carl Hanser Verlag, Munich/Vienna, 1993, page 417 ff. or page 474 ff.). They are substantially reaction mixtures composed of a polyisocyanate component and a polyol component, which contains conventional auxiliary substances and additives such as water-absorbing substances, fillers and the like. Depending on the composition of the casting compounds, moldings can be produced for a wide variety of applications. Processing of the polyurethane raw materials can, in principle, be performed by a number of different methods. In the simplest case, open molds may be filled without the use of pressure. All common mold types, including low-cost epoxy resin molds, can be used in such processes.

Catalyst-free, rapid-curing, solid polyurethane casting resin systems (density>1.0 g/cm³) are described in U.S. Pat. No. 3,966,662. This patented system includes an amine-initiated polyol, an aromatic polyisocyanate and a liquid inert modifying agent. Polyoxyalkylenes, carbonates, esters, substituted aromatics, halogenated aliphatics, organic phosphates, sulfones, etc., may be used as modifying agents. These casting resin systems cure without external heating in less than 5 minutes to form moldings that are easy to demold. Among others, the reaction of diethylene triamine-initiated polyether with toluene diisocyanate in the presence of an inactive polyether (molecular weight: 1500; functionality: 3) as modifying agent is described as an example.

U.S. Pat. No. 4,476,292 discloses clear, rigid and impact-resistant polyurethane casting resin systems. These systems include a prepolymer produced from an amine-initiated polyether polyol and an excess of a (cyclo)aliphatic polyisocyanate, and a polyoxyalkylene ether polyol, which is optionally used in combination with an amine-initiated polyol. The use of prepolymers and/or (cyclo)aliphatic polyisocyanates is disadvantageous from an economic perspective, however.

EP-A 265 781 describes a process for the production of polyurethane moldings having a density of from 0.8 to 1.4 g/cm³ by reacting polyisocyanates from the diphenylmethane series with selected compounds having groups that are capable of reacting with isocyanate groups, in which a polyether polyol having a molecular weight of from 500 to 999 g/mol and at least 30 wt. % of ethylene oxide units incorporated into polyether chains is used. The type and proportions of the compounds having groups that are capable of reacting with isocyanate groups are selected so that the average hydroxyl value of the mixture formed from these components is greater than 300. Such reaction mixtures are capable of producing moldings having complex geometry and high surface quality. The material has a high inherent rigidity and good strength (flexural modulus of elasticity>1800 N/mm²) even with thin walls. The polyurethane-forming materials are processed by means of the reaction injection molding process (RIM process). However, the process permits only short reaction times, limiting the weight of the moldings that are produced. Moreover, in comparison with the casting process described above, the molds that are used (generally made from aluminum or steel), the mold carrier and the process engineering are relatively complex and cost-intensive.

### SUMMARY OF THE INVENTION

It was therefore an object of the present invention to provide a simple and inexpensive process for producing solid polyurethane moldings, particularly, moldings having thin walls and a complex geometry.

This and other objects which will be apparent to those skilled in the art are accomplished by reacting an isocyanate of the diphenylmethane series with a polyol component that includes at least 30 wt. % of an amine-initiated polyether polyol having a number average molecular weight of from 149 to 999 g/mol and at least 25 wt. % of a polyether polyol having a number average molecular weight of from 1,000 to 16,000 g/mol and a maximum of 80% primary hydroxyl groups.

### DETAILED DESCRIPTION OF THE INVENTION

The present invention provides a process for producing solid polyurethane moldings with a flexural modulus of elasticity>1800 N/mm² (according to DIN 53 457) by the casting process, in which

a) a diisocyanate and/or polyisocyanate from the diphenylmethane series is reacted with a polyol component that includes

b) from 30 to 70 wt. %, relative to the total weight of components b) to d), of at least one polyether polyol having a number-average molecular weight of from 149 to 999 g/mol, preferably from 200 to 500 g/mol, which is initiated with an aliphatic amine, preferably ethylene diamine,

c) from 25 to 50 wt. %, relative to the total weight of components b) to d), of at least one polyether having a number-average molecular weight of from 1,000 to 16,000 g/mol, preferably from 2,000 to 6,000 g/mol, having at least one group capable of reacting with an isocyanate group and having a maximum of 80%, preferably a maximum of 5%, of primary hydroxyl groups,

d) from 0 to 30 wt. %, relative to the total weight of components b) to d), of a polyether polyol initiated with a polyhydroxyl compound and having a (number-average) molecular weight of from 62 to 999 g/mol, optionally in the presence of

e) a catalyst that accelerates the isocyanate addition reaction, and optionally

f) any of the auxiliary substances and additives known from polyurethane chemistry,

with the type and proportions of components b) to d) being selected so that the average hydroxyl value of the mixture formed from these components is greater than 300 mg KOH/g.

The starting component a) is at least one diisocyanate and/or polyisocyanate selected from the diphenylmethane series which is liquid at room temperature. Suitable isocyanates include: the derivatives of 4,4′-diisocyanatodiphenylmethane that are liquid at room temperature, e.g. polyisocyanates having urethane groups, such as those produced in accordance with DE-PS 16 18 380 by reacting 1 mol of 4,4′-diisocyanatodiphenylmethane with 0.05 to 0.3 mol of a low-molecular diol or triol, preferably, a polypropylene glycol with a molecular weight below 700; and any of the diisocyanates based on 4,4′-diisocyanatodiphenylmethane having carbodiimide and/or uretonimine groups, such as those produced in accordance with U.S. Pat. No. 3,449,256. Other very suitable isocyanates are mixtures of 4,4′-diisocyanatodiphenylmethane with 2,4′- and optionally, 2,2′-diisocyanatodiphenylmethane, which are liquid at room temperature and are optionally correspondingly modified. Also very suitable are mixtures of polyisocyanates from the diphenylmethane series that are liquid at room temperature, which in addition to the cited isomers contain their higher homologues, and which are accessible by known means by phosgenation of aniline-formaldehyde condensates. Modification products of these polyisocyanate mixtures having urethane and/or carbodiimide groups are also suitable. Also very suitable are reaction products of diisocyanates and/or polyisocyanates with fatty acid esters acting as internal release agents, such as are described in DE-OS 2 319 648. Modification products of the cited diisocyanates and polyisocyanates having allophanate or biuret groups are also suitable as component a). The polyisocyanate component a) generally has an average NCO functionality of from 2.0 to 3.5, preferably, from 2.5 to 3.3.

Component b) is an amine-initiated polyether polyol or mixture of amine-initiated polyether polyols having a (number-average) molecular weight of from 149 to 999 g/mol, preferably, from 200 to 500 g/mol. Suitable polyethers b) include those that can be obtained by known means such as by addition of an alkylene oxide to a starter molecule. Preferred starter compounds are ammonia and compounds having at least one primary or secondary amino group. Examples of such preferred amine initiators include: aliphatic amines such as 1,2-diaminoethane, oligomers of 1,2-diaminoethane (for example diethylene triamine, triethylene tetramine or pentaethylene hexamine), ethanolamine, diethanolamine, 1,3-diaminopropane, 1,3-diaminobutane, 1,4-diaminobutane, 1,2-diaminohexane, 1,3-diaminohexane, 1,4-diaminohexane, 1,5-diaminohexane, 1,6-diaminohexane; aromatic amines such as 1,2-diaminobenzene, 1,3-diaminobenzene, 1,4-diaminobenzene, 2,3-diaminotoluene, 2,4-diaminotoluene, 3,4-diaminotoluene, 2,5-diaminotoluene, 2,6-diaminotoluene, 2,2′-diaminodiphenylmethane, 2,4′-diaminodiphenylmethane, 4,4′-diaminodiphenylmethane; and aromatic amines which are obtained by acid-catalyzed condensation of aniline with formaldehyde. The starter compounds can be used alone or in a mixture. The alkylene oxides oxiran, methyl oxiran and ethyl oxiran are preferably used. These can be used alone or in a mixture. If used in a mixture, it is possible for the alkylene oxides to be reacted randomly or blockwise or both in succession. More details can be found in “Ullmanns Encyclopädie der industriellen Chemie”, Volume A21,1992, p. 670 ff. The substantial point is that aliphatic polyamines, particularly preferably ethylene diamine, are preferably used as starter molecule and component b) is used in a quantity of 30 to 70 wt. %, relative to the weight of components b) to d).

Component c) is a polyether having from 1 to 8 primary and/or secondary hydroxyl groups and having a number-average molecular weight of from 1,000 to 16,000 g/mol, preferably from 2,000 to 6,000 g/mol. This polyol preferably has an average hydroxyl functionality of from 1.5 to 3.5 and a content of primary OH groups of <80%, most preferably <5%. Component c) is most preferably a polyether polyol of the type obtained by exclusive use of propylene oxide as alkylene oxide in the alkoxylation reaction.

The poly(oxyalkylene) polyols c) useful in the practice of the present invention can be produced by known means by polyaddition of an alkylene oxide to a polyfunctional starter compound in the presence of a suitable catalyst. The poly(oxyalkylene) polyol used in the practice of the present invention is preferably produced with a highly reactive double metal cyanide catalyst from a starter compound having an average of from 1 to 8, preferably, from 1.5 to 3.5, active hydrogen atoms and one or more alkylene oxides, such as those described in EP-A 761 708. Preferred starter compounds are molecules with two to eight hydroxyl groups per molecule, such as water, triethanolamine, 1,2-ethanediol, 1,2-propanediol, 1,3-propanediol, diethylene glycol, dipropylene glycol, triethylene glycol, tripropylene glycol, 1,2-butanediol, 1,3-butanediol, 1,4-butanediol, 1,2-hexanediol, 1,3-hexanediol, 1,4-hexanediol, 1,5-hexanediol, 1,6-hexanediol, glycerol, trimethylol propane, pentaerythritol, sorbitol and sucrose. The starter compounds can be used alone or in a mixture. The alkylene oxides oxiran, methyl oxiran and ethyl oxiran are preferably used. These can be used alone or in a mixture. If used in a mixture, it is possible for the alkylene oxides to be reacted randomly or blockwise or both in succession. More details can be found in “Ullmanns Encyclopädie der industriellen Chemie”, Volume A21,1992, p. 670 ff.

Also suitable for use in the practice of the present invention are higher-molecular polyhydroxypolyethers in which high-molecular weight polyadducts or polycondensates or polymers are present in finely dispersed, dissolved or grafted form. Such modified polyhydroxyl compounds may be obtained, for example, by allowing a polyaddition reaction (e.g. reactions between polyisocyanates and amino-functional compounds) or a polycondensation reaction (e.g. between formaldehyde and phenols and/or amines) to proceed in situ in the compounds having hydroxyl groups (as described in DE-AS 11 68 075, for example). Polyhydroxyl compounds modified with vinyl polymers, such as those obtained, e.g., by polymerization of styrene and acrylonitrile in the presence of a polyether (e.g., according to U.S. Pat. No. 3,383,351) or a polycarbonate polyol (e.g., according to U.S. Pat. No. 3,637,909), are also suitable as component c) in the practice of the present invention.

Examples of the cited compounds for use according to the invention as component c) are described e.g. in Kunststoff-Handbuch, Volume VII “Polyurethane”, 3^{rd} edition, Carl Hanser Verlag, Munich/Vienna, 1993, pages 57 to 67 and pages 88 to 90.

The substantial point is that component c) is used in a quantity of from 25 to 50 wt. %, relative to the total weight of components b) to d).

Component d) which can optionally be used is a polyether having from 1 to 8 primary and/or secondary hydroxyl groups and having a number-average molecular weight of from 62 to 999. The polyether preferably has an average OH functionality of from 1.5 to 3.5. Component d) is most preferably a polyether polyol that has a high proportion of primary hydroxyl groups or that has been obtained by exclusive use of ethylene oxide as the alkylene oxide in the alkoxylation reaction.

The poly(oxyalkylene) polyols d) that are used in the practice of the present invention can be produced by known means such as by the polyaddition of an alkylene oxide to a polyfunctional starter compound in the presence of a suitable catalyst. Preferred starter compounds are molecules with from two to eight hydroxyl groups per molecule, such as water, triethanolamine, 1,2-ethanediol, 1,2-propanediol, 1,3-propanediol, diethylene glycol, dipropylene glycol, triethylene glycol, tripropylene glycol, 1,2-butanediol, 1,3-butanediol, 1,4-butanediol, 1,2-hexanediol, 1,3-hexanediol, 1,4-hexanediol, 1,5-hexanediol, 1,6-hexanediol, glycerol, trimethylol propane, pentaerythritol, sorbitol and sucrose. The starter compounds can be used alone or in a mixture. The alkylene oxides oxiran, methyl oxiran and ethyl oxiran are preferably used. The alkylene oxides can be used alone or in a mixture. If used in a mixture, it is possible for the alkylene oxides to be reacted randomly or blockwise or both in succession. More details can be found in “Ullmanns Encyclopädie der industriellen Chemie”, Volume A21, 1992, p. 670 ff.

Suitable examples of catalysts e) that can optionally be used in the practice of the present invention are, in particular, tertiary amines of known type, e.g., triethylamine, tributylamine, N-methyl morpholine, N-ethyl morpholine, N-cocomorpholine, N,N,N′,N′-tetramethyl ethylene diamine, 1,4-diazabicyclo[2,2,2]octane, N-methyl-N′-dimethyl aminoethyl piperazine, N,N-dimethyl cyclohexylamine, N,N,N′,N′-tetramethyl-1,3-butane diamine, N,N-dimethylimidazole-β-phenyl ethylamine, 1,2-dimethyl imidazole and 2-methyl imidazole. Organic metal catalysts, in particular organic tin catalysts, such as tin(II) salts of carboxylic acid such as tin(II) acetate, tin(II) octoate, tin(II) ethyl hexoate and tin(II) laurate and the dialkyl tin salts of carboxylic acids, such as dibutyl tin diacetate, dibutyl tin dilaurate, dibutyl tin maleate and dioctyl tin diacetate, can also be used alone or in combination with any of the tertiary amines. From 0.01 to 5 wt. %, relative to the total weight of components b) to f), of catalyst or catalyst combination are preferably used in the practice of the present invention, preferably from 0.05 to 2 wt. %, relative to the total weight of components b) to f). Other examples of catalysts and details of the mode of action of the catalysts are described in Kunststoff-Handbuch, Volume VII “Polyurethane”, 3^{rd} edition, Carl Hanser Verlag, Munich/Vienna, 1993, on pages 104-110.

Examples of the auxiliary substances and additives f) that can optionally be incorporated include water-absorbing substances, surface-active substances, stabilizers and internal mold release agents.

Both compounds that are highly reactive with water, such as tris(chloroethyl) orthoformate, and water-binding fillers, e.g. alkaline-earth oxides, zeolites, aluminum oxides and silicates, are suitable as water-absorbing substances.

Suitable surface-active substances are compounds that serve to support homogenization of the starting materials. Examples of such surface active substances are the sodium salts of fatty acids and salts of fatty acids with amines such as oleic acid diethylamine and stearic acid diethanolamine.

Suitable examples of stabilizers are, above all, water-soluble polyether siloxanes. These compounds are generally structured in such a way that a copolymer of ethylene oxide and propylene oxide is bonded with a polydimethyl siloxane radical. Such stabilizers are described, for example, in U.S. Pat. No. 2,764,565.

Examples of the auxiliary substances f) that can optionally be incorporated also include any of the known internal mold release agents such as those described in DE-OS 24 04 310. Preferred release agents are salts of fatty acids with at least 12 aliphatic carbon atoms and primary mono-, di- or polyamines with two or more carbon atoms or amines having amide or ester groups, which have at least one primary, secondary or tertiary amino group; saturated and/or unsaturated esters of mono- and/or polyfunctional carboxylic acids and polyfunctional alcohols having COOH and/or OH groups and hydroxyl values or acid values of at least 5; ester-like reaction products of ricinoleic acid and long-chain fatty acids; salts of carboxylic acids and tertiary amines; and natural and/or synthetic oils, fats and waxes. The oleic acid or tall oil fatty acid salts of the amide group-containing amine obtained by reacting N-dimethyl aminopropylamine with oleic acid or tall oil fatty acid or the salt of 2 mol oleic acid and 1 mol 1,4-diazabicyclo[2,2,2]octane are particularly preferred.

In addition to these release agents that are preferably used and have been cited by way of example, other known release agents of the prior art can also, in principle, be used in the practice of the present invention, either alone or in combination with the preferred release agents. These other suitable release agents include: the reaction products of fatty acid esters and polyisocyanates according to DE-OS 23 07 589; the reaction products of polysiloxanes having reactive hydrogen atoms with monoisocyanates and/or polyisocyanates according to DE-OS 23 56 692; esters of polysiloxanes having hydroxymethyl groups with monocarboxylic and/or polycarboxylic acids according to DE-OS 23 63 452; and salts of amino group-containing polysiloxanes and fatty acids according to DE-OS 24 31 968. The cited internal mold release agents, if used at all, are used in a quantity of up to 15 wt. %, preferably up to 10 wt. %, relative to the entire reaction mixture.

Other additives f) that can optionally be incorporated are fillers, for example. Fillers, especially reinforcing fillers, that can be cited by way of example include siliceous minerals, for example phyllosilicates such as antigorite, serpentine, hornblendes, amphibiles, chrysotile, talc; metal oxides such as kaolin, aluminum oxides, titanium oxides and iron oxides, metal salts such as chalk, barytes and inorganic pigments, such as cadmium sulfide, zinc sulfide and glass, asbestos powder, etc. Natural and synthetic fibrous minerals are preferably used, such as asbestos, wollastonite and in particular glass fibers of varying lengths, which can optionally be smoothed. Fillers can be used individually or in a mixture. If used at all, the fillers are advantageously added to the reaction mixture in quantities of up to 50 wt. %, preferably up to 30 wt. %, relative to the total weight of components b) to f).

Examples of suitable flame retardants that can optionally be incorporated include tricresyl phosphate, tris-2-chloroethyl phosphate, tris-chloropropyl phosphate and tris-2,3-dibromopropyl phosphate. In addition to the already cited halogen-substituted phosphates, inorganic flame retardants, such as aluminum oxide hydrate, ammonium polyphosphate and calcium sulfate, can also be used. It has generally proven convenient to use up to 25 wt. % of the cited flame retardants, relative to the sum of components b) to f).

Other additives f) that can optionally be incorporated are monohydric alcohols such as butanol, 2-ethyl hexanol, octanol, dodecanol and/or cyclohexanol, which can optionally be incorporated in order to bring about a desired chain termination. There are generally no such monohydric alcohols in the reaction mixtures, however.

In order to improve the surface quality of the molding, gas can be introduced into the reaction mixture. This is done by incorporating the gas into the mixture of components b) to f) by means of a venturi tube or a hollow stirrer (according to DE-OS 32 44 037) in a quantity of at least 10 vol. %, preferably at least 20 vol. % (relative to normal pressure).

More details about the conventional auxiliary substances and additives can be found in the specialist literature, for example Kunststoff-Handbuch, Volume VII “Polyurethane”, 3rd edition, Carl Hanser Verlag, Munich/Vienna, 1993, page 104 ff.

In the process of the present invention, components b) to d) are mixed to form a “polyol component”, which is then processed with the polyisocyanate component a) by means of the casting process. The catalysts e) and auxiliary substances and additives f) that are optionally used are generally added to the “polyol component” or to one or more of components b) to d) before production of the “polyol component”, but this is not absolutely necessary because catalysts and auxiliary substances and additives that are compatible with the polyisocyanate component a) can also be incorporated into the polyisocyanate.

Either component a) and/or the “polyol component” composed of components b) to d) preferably displays a certain degree of branching. Thus if difunctional polyisocyanates, i.e. diisocyanates, are used as component a), the average functionality of the “polyol component” should preferably be at least 2.30. If exclusively difunctional structural components b) to d) are used, the polyisocyanate component should preferably have an NCO functionality of at least 2.30. On the basis of an isocyanate value of 100, the average functionality of all structural components, i.e. the arithmetic mean of the functionality of component a) and the average functionality of the “polyol component”, should preferably be at least 2.15.

When carrying out the process of the present invention, the proportions of the reaction components are calculated in a way such that the isocyanate value in the reaction mixture is from 70 to 140, preferably from 95 to 125. Isocyanate value refers herein to the quotient of the number of isocyanate groups and the number of isocyanate-reactive groups, multiplied by 100.

The mixture that is formed when the reaction components are mixed together is introduced into an appropriate mold. The amount of mixture introduced into the mold is generally calculated in such a way that the moldings obtained have a density of from 1.0 to 1.2 g/cm³. If mineral fillers, in particular, are used, moldings with a density above 1.2 g/cm³ can result. The range from 20 to 80° C., preferably 20 to 40° C., is preferably chosen as the starting temperature of the mixture introduced into the mold. The mold temperature is generally from 20 to 100° C., preferably from 20 to 70° C. The moldings can generally be demolded after a residence time in the mold of from 3 to 5 minutes.

The process of the present invention is suitable, in particular, for the production of high-grade rigid moldings, e.g. industrial housings or furniture components.

Having thus described the invention, the following Examples are given as being illustrative thereof.

### EXAMPLES

The reaction components used in the examples below were processed by means of the casting process. Structural components b) to d) having groups capable of reacting with isocyanate groups were first combined together with the catalysts e) and auxiliary substances and additives f) to form a “polyol component” and then processed with the polyisocyanate component a) while retaining a defined isocyanate value.

The reaction components, which were held at a temperature of approximately 25° C., were metered into a mixing vessel with the aid of a 2-component metering-mixing unit or by weighting, and intensively mixed so that as few air bubbles as possible were stirred into the reaction mixture. The reaction mixture was then introduced into a mold. Before being filled, the temperature of the epoxy resin mold was 25° C. The internal walls of the mold were coated with an external mold release agent.

The reaction time for the polyurethane system depends on the intensity of mixing and the temperature of the raw materials. Under the above-stated conditions, the reaction time was approximately 35 seconds. After a demolding time of approximately 3 minutes, the moldings were removed from the mold. After cooling, they could be used or inspected immediately.

Raw materials

Polyisocyanate a1): Mixture of polyisocyanates from the diphenylmethane series, produced by phosgenation of an aniline-formaldehyde condensate; NCO content: 31.8 wt. %, average NCO functionality: 2.8; viscosity (25° C.): 100 mPa·s.

Polyisocyanate a2): Reaction product of a polyester polyol composed of oleic acid, adipic acid and pentaerythritol with a number-average molecular weight of 1100 g/mol and a mixture of polyisocyanates from the diphenylmethane series, produced by phosgenation of an aniline-formaldehyde condensate; NCO content: 28 wt. %; viscosity (25° C.): 403 mPa·s.

Component b): Propoxylation product of ethylene diamine, number-average molecular weight: 356 g/mol, functionality: 4.

Component c1): Polyether polyol, produced by alkoxylation of trimethylol propane using a mixture of propylene oxide and ethylene oxide in the weight ratio 74:16 with subsequent propoxylation of the alkoxylation product using 10 wt. % propylene oxide, relative to the total amount of alkylene oxide used. Number-average molecular weight: 3740 g/mol, functionality: 3.

Component c2): Propoxylation product of 1,2-propylene glycol, number-average molecular weight: 2004 g/mol, functionality: 2.

Component d): Ethoxylation product of trimethylol propane, number-average molecular weight: 660 g/mol, functionality: 3.

Component e): 1,4-diazabicyclo[2,2,2]octane in dipropylene glycol (33 wt. %).

Component f1): Zeolite (Baylith® T paste, Bayer AG).

Component f2): Polyether siloxane (Tegostab® B 8411, Goldschmidt AG, D-45127 Essen).

The components were reacted in the quantities specified in Table 1. Flexural modulus and impact resistance were determined according to ASTM-D 790 and DIN EN ISO 179/1 and are reported in Table 1.

TABLE 1

| Component/example | Dimension | 1 | 2 | 3 | 4 |
|---|---|---|---|---|---|
| Component b) | [parts by weight] | 49 | 49 | 49 | 44 |
| Component c1) | [parts by weight] | 33 | 33 | | |
| Component c2) | [parts by weight] | | | 33 | 27 |
| Component d) | [parts by weight] | 15 | 15 | 15 | 27 |
| Component e) | [parts by weight] | 1 | | | 0.3 |
| Component f1) | [parts by weight] | 3 | 3 | 3 | |
| Component f2) | [parts by weight] | | | | 1 |
| OH value (“polyol” | [mg KOH/g] | 358 | 356 | 360 | 361 |
| component) | | | | | |
| Component a1) | [parts by weight] | 100 | 100 | 103 | |
| Component a2) | [parts by weight] | | | | 111 |
| Reaction time | [sec] | 35 | 35 | 35 | 35 |
| Demolding time | [min] | 3 | 3 | 3 | 3 |
| Flexural modulus | [N/mm²] | 2253 | 2256 | 2287 | 1899 |
| of elasticity | | | | | |
| Impact resistance | [kJ/m²] | 41 | 56 | 47 | 79 |

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A process for the production of a solid polyurethane molding having a flexural modulus of elasticity>1800 N/mm² (according to DIN 53 457) by the casting process comprising reacting
a) a diisocyanate and/or polyisocyanate from the diphenylmethane series
with a polyol component comprising
b) from 30 to 70 wt. %, relative to total weight of components b),
c) and d), of a polyether polyol having a number-average molecular weight of from 149 to 999 g/mol, which is initiated with an aliphatic amine,
c) from 25 to 50 wt. %, relative to total weight of components b), c) and d), of a polyether having a number-average molecular weight of from 1,000 to 16,000 g/mol, at least one group capable of reacting with an isocyanate group and having a maximum of 80% of primary hydroxyl groups,
d) from 0 to 30 wt. %, relative to total weight of components b), c) and d), of a polyether polyol started with a polyhydroxyl compound and having a (number-average) molecular weight of from 62 to 999 g/mol, optionally in the presence of
e) a catalyst that accelerates an isocyanate addition reaction, and optionally
f) any of the auxiliary substances and additives known to those skilled in the art of polyurethane chemistry,
in which the type and proportions of components b) to d) are selected so an average hydroxyl value of the mixture formed from these components is greater than 300 mg KOH/g.

2. The process of claim 1 in which the molecular weight of component b) is from 200 to 500 g/mol.

3. The process of claim 1 in which the molecular weight of component c) is from 2,000 to 6,000 g/mol.

4. The process of claim 1 in which the reaction is carried out in a mold for the production of an article having a thin wall.

5. The process of claim 1 in which the reaction is carried out in mold for the production of a molded article having a complex geometry.

6. A molded article produced by the process of claim 1.

7. A molded article having thin walls and a complex geometry produced by the process of claim 1.
